(19) United States
(12) Patent Application Publication
(10) Pub. No.: US 2017/0347325 A1
(43) Pub. Date: Nov. 30, 2017

(54) WIRELESS COMMUNICATION METHODS AND DEVICES

(71) Applicant: MediaTek Inc., Hsin-Chu (TW)

(72) Inventors: Meng-Shiang LIN, New Taipei City (TW); Yi-Ting CHENG, Taipei City (TW)

(21) Appl. No.: 15/168,494

(22) Filed: May 31, 2016

(51) Int. Cl. H04W 52/34; H04W 72/04; H04W 52/18

(52) U.S. Cl. CPC H04W 52/34; H04W 52/18; H04W 72/0413

(57) ABSTRACT

The wireless communication methods and devices are provided. The wireless communication method includes the steps of determining whether uplink data for an uplink transmission includes control messages; and forbidding a Tx power throttling procedure from being performed when the uplink data includes the control messages. When the uplink data does not include the control message the transmission power throttling procedure is performed.

### BACKGROUND OF THE INVENTION

### Field of the Invention

The invention generally relates to a wireless communication technology, and more particularly, to a wireless communication method for avoiding the control messages being lost during the transmission (Tx) power throttling procedure.

### Description of the Related Art

Wireless communication systems have been widely deployed to provide various telecommunication services such as telephony, video, data, messaging, and broadcast. Typical wireless communication systems may employ multiple-access technologies capable of supporting communication with multiple users by sharing available system resources (e.g., bandwidth, transmission power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Teletransmissions System (UMTS) mobile standard promulgated by the Third Generation Partnership Project (3GPP). It is designed to better support mobile broadband Internet access by improving spectral efficiency, lowering costs, improving services, making use of new spectrums, and integrating better with other open standards using OFDMA on downlinks (DL), and SC-FDMA on uplinks (UL) and multiple-input multiple-output (MIMO) antenna technology.

In current wireless communication devices, the data rate has become higher that needs more processor computing power and more UL power amplify (PA) power. These powers will transfer to heat. However, small and thin wireless communication devices are hard to distribute heat and will cause the IC circuit crash even burn out. For example, the uplink data rate of LTE may over 50 Mbps. Such high rate would cause greater power consumption, and lead to extreme heat issues. In addition, some components, such as power amplifier may exceed maximum safe temperature when it's operating at high power.

The TX power throttling scheme is one of the solutions for the higher UL power consumption problem of the wireless communication devices. The TX power throttling scheme can directly reduce Tx power without UL data throttling. In addition, it may work in better channel quality without UL throughput loss. However, the TX power throttling scheme will suffer disconnection in bad channel quality or cell boundary due to insufficient UL Tx power, e.g. the control message will be lost during the TX power throttling procedure.

### BRIEF SUMMARY OF THE INVENTION

Wireless communication methods and devices are provided to overcome the problems mentioned above.

An embodiment of the invention provides a wireless communication method. The wireless communication method comprises the steps of determining whether uplink data for an uplink transmission comprises control messages; and forbidding a Tx power throttling procedure from being performed when the uplink data comprises the control messages.

The wireless communication method further comprises the steps of determining whether a system temperature is higher than a threshold; and determining whether there is the uplink transmission when the system temperature is higher than the threshold. The wireless communication method further comprises the step of performing the Tx power throttling procedure when the uplink data does not comprise the control messages.

An embodiment of the invention provides a wireless communication device. The wireless communication device comprises a processor. The processor is configured to determine whether uplink data for an uplink transmission comprises control messages and forbid performing a Tx power throttling procedure when the uplink data comprises the control messages.

An embodiment of the invention provides a wireless communication method. The wireless communication method comprises the steps of determining whether uplink data for an uplink transmission comprises user data or a control message; applying a first transmission power control when the uplink data comprises the user data; and applying a second transmission power control when the uplink data comprises the control message; wherein the first transmission power control is different from the second transmission power control.

An embodiment of the invention provides a wireless communication device. The wireless communication device comprises a processor. The processor is configured to determine whether uplink data for an uplink transmission comprises user data or a control message. When the uplink data comprises the user data the processor applies a first transmission power control. When the uplink data comprises the control message the processor applies a second transmission power control. The first transmission power control is different from the second transmission power control.

In some embodiments of the invention, the processor further determines whether a system temperature is higher than a threshold and determines whether there is the uplink transmission when the system temperature is higher than the threshold. When the uplink data does not comprise the control messages the processor further performs the Tx power throttling procedure.

In some embodiments of the invention, the control messages comprise HARQ ACK message, scheduling request (SR) messages, channel quality indicator (CQI) message, pre-coding matrix indicator (PMI) message, rank indicator (RI), and sounding reference symbol (SRS) message in layer 1.

In some embodiments of the invention, the control messages comprise RRCConnectionSetupComplete message RRCConnectionReconfigurationComplete message, MeasurementReport message, ACK/NACK message in layer 2.

Other aspects and features of the invention will become apparent to those with ordinary skill in the art upon review of the following descriptions of specific embodiments of methods.

### BRIEF DESCRIPTION OF THE DRAWINGS

The invention will become more fully understood by referring to the following detailed description with reference to the accompanying drawings, wherein:

FIG. 1 is a block diagram of a mobile communications system 100 according to an embodiment of the invention;

FIG. 2 is a flow chart illustrating a wireless communication method according to an embodiment of the invention.

FIG. 3 is a flow chart illustrating a wireless communication method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

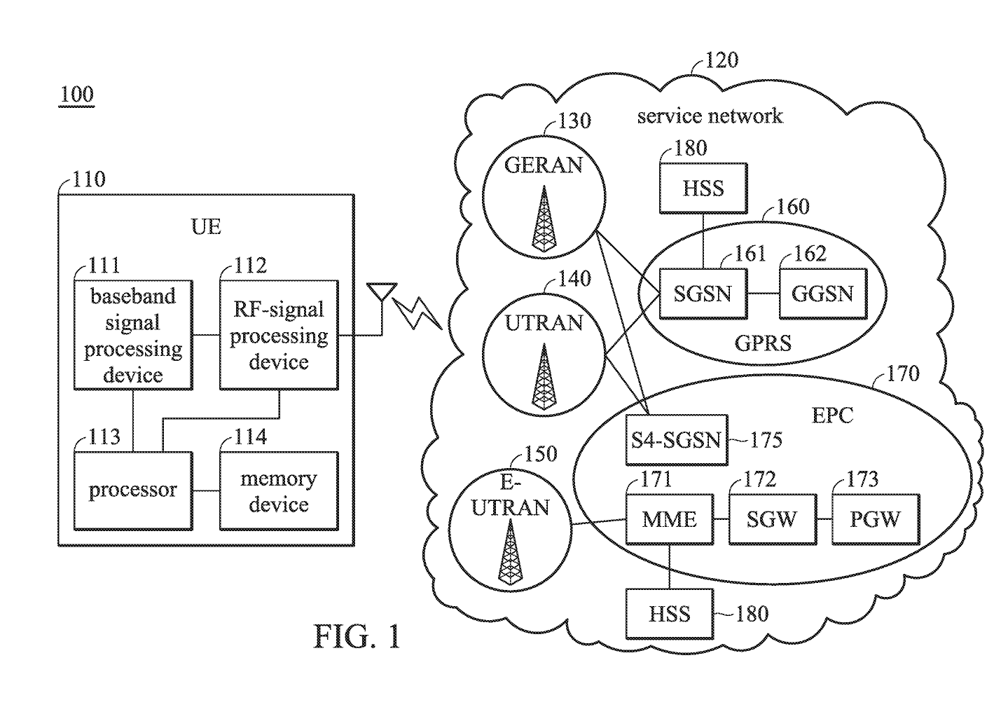

FIG. 1 is a block diagram of a mobile communications system 100 according to an embodiment of the invention. The system 100 comprises User Equipment (UE) 110 and a service network 120. The UE 110 may be a mobile communications device, such as a cellular phone, a smartphone modem processor, a data card, a laptop stick, a mobile hotspot, a USB modem, a tablet, etc.

The UE 110 may comprise at least a baseband signal processing device 111, a radio frequency (RF) signal processing device 112, a processor 113, a memory device 114, and an antenna module comprising at least one antenna. Note that, in order to clarify the concept of the invention, FIG. 1 presents a simplified block diagram in which only the elements relevant to the invention are shown. However, the invention should not be limited to what is shown in FIG. 1.

The RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, etc.

The baseband signal processing device 111 may further process the baseband signals to obtain information or data transmitted by the peer communications apparatus. The baseband signal processing device 111 may also comprise a plurality of hardware elements to perform baseband signal processing. The baseband signal processing may comprise analog-to-digital conversion (ADC)/digital-to-analog conversion (DAC), gain. adjustment, modulation/demodulation, encoding/decoding, and so on.

The processor 113 may control the operations of the baseband signal processing device 111 and the RF signal processing device 112. According to an embodiment of the invention, the processor 113 may also be arranged to execute the program codes of the software module(s) of the corresponding baseband signal processing device 111 and/or the RF signal processing device 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software module(s).

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

In addition, in some embodiments of the invention, the processor 113 may be configured inside of the baseband signal processing device 111, or the UE 110 may comprise another processor configured inside of the baseband signal processing device 111. Thus the invention should not be limited to the architecture as shown in FIG. 1.

The service network 120 may comprise a GSM EDGE Radio Access Network (GERAN) 130, a Universal Terrestrial Radio Access Network (UTRAN) 140, an Evolved UTRAN (E-UTRAN) 150, a General Packet Radio Service (GPRS) subsystem 160 and an Evolved Packet Core (EPC) subsystem 170. The GERAN 130, UTRAN 140 and E-UTRAN 150 may be in communication with the GPRS subsystem 160 or the EPC subsystem 170, wherein the GERAN 130, UTRAN 140 and E-UTRAN 150 allow connectivity between the UE 110 and the GPRS subsystem 160 or the EPC subsystem 170 by providing the functionality of wireless transmission and reception to and from the UE 110 for the GPRS subsystem 160 or the EPC subsystem 170, and the GPRS subsystem 160 or the EPC subsystem 170 signals the required operation to the GERAN 130, UTRAN 140 and E-UTRAN 150 for providing wireless services to the UE 110. The GERAN 130, UTRAN 140 and E-UTRAN 150 may contain one or more base stations (or called NodeBs or eNodeBs) and Radio Network Controllers (RNCs). Specifically, the GPRS subsystem 160 includes a Serving GPRS (General Packet Radio Services) Support Node (SGSN) 161 and a Gateway GPRS Support Node (GGSN) 162, wherein the SGSN 161 is the key control node for packet routing and transfer, mobility management (e.g., attach/detach and location management), session management, logical link management, and authentication and charging functions, etc., and the GGSN 162 is responsible for Packet Data Protocol (PDP) address assignments and inter-working with external networks. The EPC subsystem 170 may comprise a Mobility Management Entity (MME) 171, which may be responsible for idle mode UE tracking, paging procedures, and attachment and activation processes. The EPC subsystem 170 may also comprise a Servicing Gateway (SGW) 172, which may be responsible for the routing and forwarding of data packets. The EPC subsystem 170 may also include a Packet data network Gateway (PGW) 173, which may be responsible for providing connectivity from the UE 110 to external networks. Both the SGSN 161 and the MME 171 may be in communication with Home Subscriber Server (HSS) 180 which may provide device identification information, an International Mobile Subscriber Identity (IMSI), etc. It should be appreciated that the EPC subsystem 170 may also comprise a S4-SGSN 175, thereby allowing the GERAN 130 or UTRAN 140 to be accessed when the GPRS subsystem 160 is replaced by the EPC subsystem 170. Additionally, the service network 120 may further include other functional entities, such as a Home Location Register (HLR) (not shown) which is a central database storing user-related and subscription-related information, and the invention is not limited thereto. In an embodiment of the invention, the service network 120 may further comprise a Code Division Multiple Access (CDMA) network.

In an embodiment of the invention, the processor 113 may monitor the system temperature of the UE 110 to determine whether the system temperature of the UE 110 is higher than a threshold. If the processor 113 determines the system temperature of the UE 110 is not higher than the threshold, the processor 113 will continue to perform normal operation. If the processor 113 determines the system temperature of the UE 110 is higher than the threshold, the processor 113 will determine whether an uplink (UL) transmission from the UE 110 to the network 120 occurs. If the processor 113 determines that the uplink transmission is being performed in the UE 110 (i.e. there is uplink transmission), the processor 113 determines that the uplink transmission may cause the system temperature to increase. Therefore, the processor will determine whether perform a Tx power throttling procedure to reduce the system temperature.

In an embodiment of the invention, before performing a transmission (Tx) power throttling procedure, the processor 113 may determine whether the uplink data for the uplink transmission comprises control messages (or signaling message) first. If the uplink data comprises the control messages, the processor 113 will forbid the Tx power throttling procedure from being performed to avoid the control messages is lost during the Tx power throttling procedure. If the uplink data does not comprise the control messages (i.e. the uplink data may only comprise normal user data), the processor 113 will perform the Tx power throttling procedure to reduce the system temperature.

In an embodiment of the invention, when the uplink data only comprises normal user data, the processor 113 may apply a first transmission power control, and when the uplink data comprises control messages, the processor 113 may apply a second transmission power control. In an embodiment of the invention, the first transmission power control may perform a Tx power throttling procedure. In an embodiment of the invention, the second transmission power control may forbid (not perform) the Tx power throttling procedure. In another embodiment of the invention, the second transmission power control may reduce the Tx power a little, wherein the Tx power which has been reduced is still higher than the Tx power reduced by Tx power throttling procedure is performed.

In an embodiment of the invention, the control message may comprise Hybrid. Automatic Repeat reQuest (HARQ) ACK messages, scheduling request (SR) messages, channel quality indicator (CQI) messages, pre-coding matrix indicator (PMI) messages, rank indicator (RI) messages, and sounding reference symbol (SRS) messages in Layer 1(e.g. physical (PHY) layer).

In another embodiment of the invention, the control messages comprise RRCConnectionSetupComplete message RRCConnectionReconfigurationComplete message, MeasurementReport message, ACK/NACK message in Layer 2 (e.g. a radio resource control (RRC) layer, a medium access control (MAC) layer, a radio link control (RLC) layer, and a packet data convergence protocol (PDCP)).

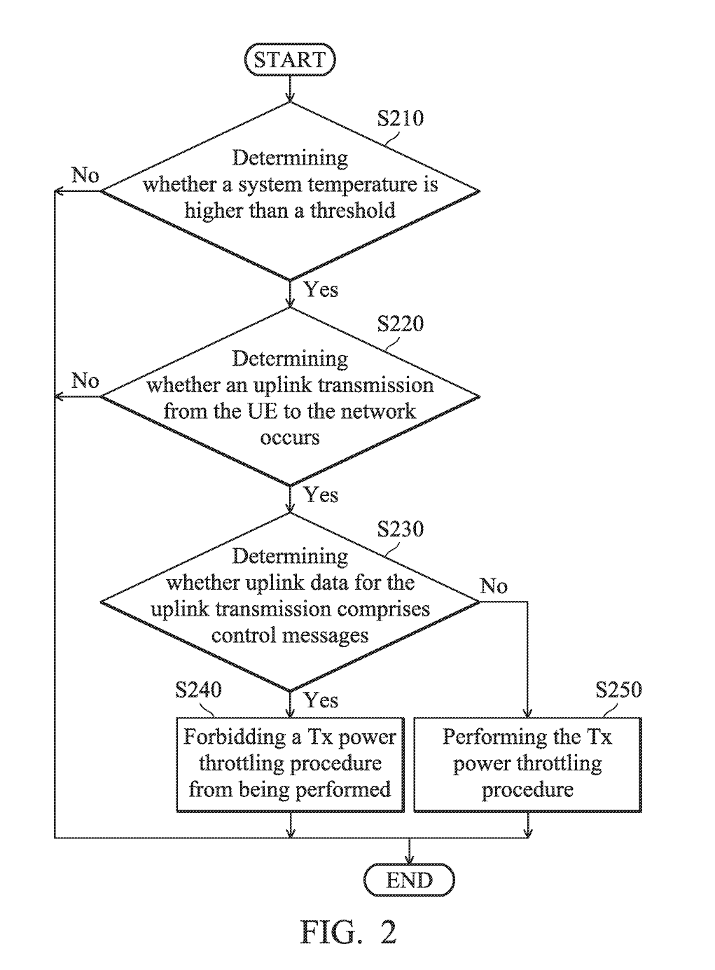

FIG. 2 is a flow chart illustrating a wireless communication method according to an embodiment of the invention. The wireless communication method is applied to the UE 110. In step 210, the UE 110 determines whether a system temperature is higher than a threshold. If the system temperature is higher than the threshold, step 220 will be performed. In step S220, the UE 110 determines whether an uplink (UL) transmission from the UE 110 to the network 120 occurs. If the system temperature is not higher than the threshold, the wireless communication method will end, and the UE 110 will continue to perform normal operations.

If the uplink (UL) transmission occurs between the UE 110 and the network 120, step S230 will be performed. In step S230, the UE 110 will further determine whether uplink data for the uplink transmission comprises control messages. If the uplink data for the uplink transmission comprises the control messages, step S240 will be performed. In step S240, the UE 110 will forbid a Tx power throttling procedure from being performed. If the uplink data for the uplink transmission does not comprise the control messages, step S250 will be performed. In step S250, the UE 110 will perform the Tx power throttling procedure.

In an embodiment of the invention, the control message may comprise HARQ ACK message, scheduling request (SR) messages, channel quality indicator (CQI) message, pre-coding matrix indicator (PMI) message, rank indicator (RI), and sounding reference symbol (SRS) message in Layer 1.

In another embodiment of the invention, the control messages comprise RRCConnectionSetupComplete message RRCConnectionReconfigurationComplete message, MeasurementReport message, ACK/NACK message in Layer 2.

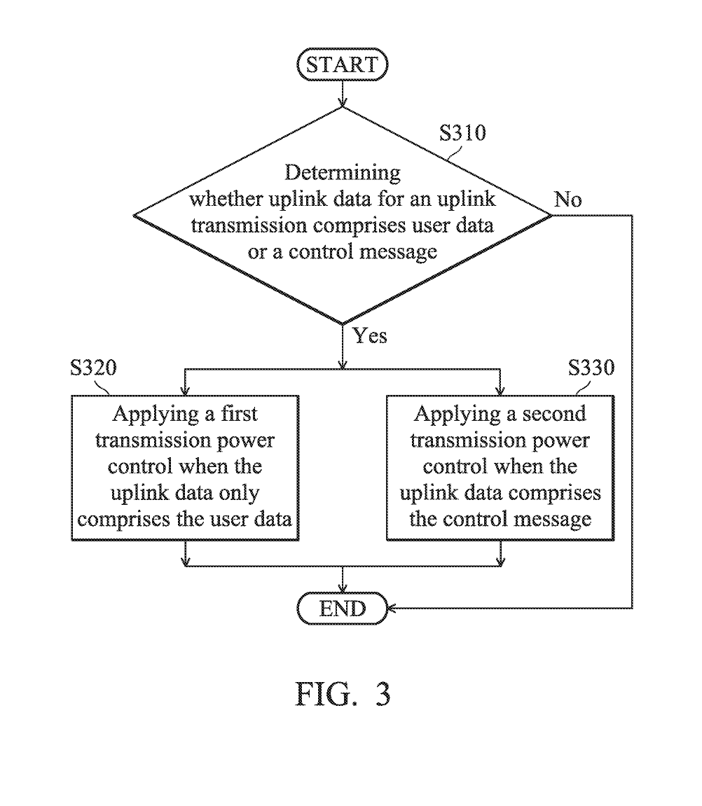

FIG. 3 is a flow chart illustrating a wireless communication method according to another embodiment of the invention. The wireless communication method is applied to the UE 110. In step S310, the UE 110 determines whether uplink data for an uplink transmission comprises user data or a control message. When the uplink data only comprises the user data, step S320 is performed. In step S320, UE 110 applies a first transmission power control. When the uplink data comprises the control message, step S330 is performed. In step S330, UE 110 applies a second transmission power control.

In an embodiment of the invention, the first transmission power control may perform a Tx power throttling procedure. In an embodiment of the invention, the second transmission power control may forbid (not perform) the Tx power throttling procedure. In another embodiment of the invention, the second transmission power control may reduce the Tx power a little, wherein the Tx power which has been reduced is still higher than the Tx power reduced by Tx power throttling procedure is performed.

In the communication method of the invention, it allows keeping UL data transmission and it can be applied to the packet switch service of 2G/3G/4G/High data rate wireless system. In addition, in the communication method of the invention, the communication method can avoid the control messages is lost during the Tx power throttling procedure. Therefore, the user has better usage experiment than current existing solutions, especially in bad channel quality or cell boundary.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying, and/or outputting, as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communication method, comprising:
determining whether uplink data for an uplink transmission comprises a control message; and
forbidding a transmission power throttling procedure from being performed. when the uplink data comprises the control message.

2. The wireless communication method of claim 1, further comprising:
determining whether a system temperature is higher than a threshold; and
determining whether there is the uplink transmission when the system temperature is higher than the threshold.

3. The wireless communication method of claim 1, further comprising:
performing the transmission power throttling procedure when the uplink data does not comprise the control message.

4. The wireless communication method of claim 2, wherein the control message comprise HARQ ACK message, scheduling request (SR) messages, channel quality indicator (CQI) message, pre-coding matrix indicator (PMI) message, rank indicator (RI), and sounding reference symbol (SRS) message in layer 1.

5. The wireless communication method of claim 2, wherein the control message comprise RRCConnectionSetupComplete message RRCConnectionReconfigurationComplete message, MeasurementReport message, ACK/NACK message in layer 2.

6. A wireless communication device, comprising:
a processor, configured to determine whether uplink data for an uplink transmission comprises a control message and forbid performing a transmission power throttling procedure when the uplink data comprises the control message.

7. The wireless communication device of claim 6, wherein the processor further determines whether a system temperature is higher than a threshold and determines whether there is the uplink transmission when the system temperature is higher than the threshold.

8. The wireless communication device of claim 6, wherein the processor further performs the transmission power throttling procedure when the uplink data does not comprise the control message.

9. The wireless communication device of claim 6, wherein the control message comprise HARQ ACK message, scheduling request (SR) messages, channel quality indicator (CQI) message, pre-coding matrix indicator (PMI) message, rank indicator (RI), and sounding reference symbol (SRS) message in layer 1.

10. The wireless communication device of claim 6, wherein the control message comprise RRCConnectionSetupComplete message RRCConnectionReconfigurationComplete message. MeasurementReport message, ACK/NACK message in layer 2.

11. A wireless communication method, comprising:
determining whether uplink data for an uplink transmission comprises user data or a control message;
applying a first transmission power control when the uplink data comprises the user data; and
applying a second transmission power control when the uplink data comprises the control message;
wherein the first transmission power control is different from the second transmission power control.

12. The wireless communication method of claim 11, wherein the first transmission power control is to perform a transmission power throttling procedure and the second transmission power control is not to perform the transmission power throttling procedure.

13. A wireless communication device, comprising:
a processor, configured to determine whether uplink data for an uplink transmission comprises user data or a control message.
wherein when the uplink data comprises the user data the processor applies a first transmission power control;
wherein when the uplink data comprises the control message the processor applies a second transmission power control; and
wherein the first transmission power control is different from the second transmission power control.

14. The wireless communication device of claim 13, wherein the first transmission power control is to perform a transmission power throttling procedure and the second transmission power control is not to perform the transmission power throttling procedure.
